(19) United States
(12) Patent Application Publication
(10) Pub. No.: US 2003/0038445 A1
(43) Pub. Date: Feb. 27, 2003

(54) Symbiotic elastomeric non-linear spring device for mobile vehicle suspension system

(76) Inventors: Anthony D. Sutton, Fort Wayne, IN (US); Michael P. Bires, Fort Wayne, IN (US); James J. Korson, Fort Wayne, IN (US); Joseph M. Smith, Blufton, IN (US); Christian W. Bultemeier, Hoagland, IN (US); Jeffrey T. Henry, Fort Wayne, IN (US); Brian M. Millard, Fort Wayne, IN (US); Ryan S. Rochester, Fort Wayne, IN (US); Derek K. Warinner, Fort Wayne, IN (US); Robert W. Pope, Churubusco, IN (US); Paul L. Nieuwlandt, Churubusco, IN (US); Samuel J. Ford, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/209,232

(22) Filed: Jul. 31, 2002

Related U.S. Application Data
(60) Provisional application No. 60/309,280, filed on Aug. 1, 2001.

(51) Int. Cl. B60G 11/38

(52) U.S. Cl. 280/124.165

(57) ABSTRACT

A mobile vehicle suspension containing a leaf spring or set of leaf springs engaged between a forward frame bracket and a rear frame bracket; the frame brackets being engaged to face of the frame rail for each frame rail. The leaf spring is engaged to an axle through a pair of U-bolts. There is a U-bolt seat with a widened rubber spring engagement face; the U-bolt seat is sandwiched between the curved portion of the U-bolts and the steel spring. There is also a rubber spring bracket engaged to each frame rail. Each rubber spring bracket has a rubber spring that is aligned to make contact with the U-bolt seat upon a modest increase in chassis load beyond a very lightly loaded condition. Thereafter the rubber spring remains in contact with the widened rubber spring engagement face.

This is a non-provisional patent application claiming the priority of provisional patent application Serial No. 60/309,280, filed Aug. 1, 2001.

### BACKGROUND

This invention relates to a suspension system for a mobile vehicle. The suspension system uses conventional leaf springs however the incorporation and installation of a symbiotic elastomeric non-linear spring device greatly enhances the performance of the leaf springs.

### PRIOR ART

Mobile vehicle suspensions in the past have used leaf springs in suspension systems to buffer components directly engaged to the vehicle chassis from inconsistent or rough road surfaces. The balance between the spring rate needed for a good smooth ride and the spring rate needed for good handling is a very difficult problem for designers to manage using steel leaf springs alone. The steel spring responds linearly during much of its deflection. This means that the designers need to incorporate a spring with a spring with a spring rate higher than optimal for ride in order to have a spring rate necessary for higher loads to obtain good handling characteristics.

In the past this has been addressed by having springs that effectively become shorter with loading or deflection. Allowing some pivoting in the engagement clamp forward and rearward holding the springs to the chassis achieved this length reduction. This is shown in FIG. 1. Another way to handle this is with additional springs that engage after some predetermined amount of deflection. See attached FIG. 2. The problem with this is that these additional springs are still very linear after they engage. See attached FIG. 3. This gives a stepped increase in spring rate but then becomes mostly linear after that. Another way to handle this currently is to use a rubber axle stop. This stop engages close to the end of the suspension travel and very abruptly increases spring rate that causes a very noticeable change in the ride and handling characteristics with little or no warning.

What is needed and does not exist in the prior art is a suspension system that only operates on the steel spring for very lightly loaded conditions and then after a modest load increase having a rubber spring become an integral part of the suspension. What is also needed is that this suspension shifts from linear response to an increasing rate response with a fully loaded chassis.

### SUMMARY

An object of the invention is to provide a vehicle suspension system that operates on a steel leaf spring for very lightly loaded conditions and then after a modest increase in loading, a rubber spring comes into service integral to the suspension. A second object of the invention is to provide a suspension that shifts from linear response to an increasing rate response with a fully loaded chassis.

The vehicle for which this suspension is designs contains a chassis with two parallel frame rails. The suspension contains a leaf spring or set of leaf springs engaged between a forward frame bracket and a rear frame bracket; the frame brackets being engaged to face of the frame rail for each frame rail. The leaf spring is engaged to an axle through a pair of U-bolts. There is a U-bolt seat with a widened rubber spring engagement face; the U-bolt seat is sandwiched between the curved portion of the U-bolts and the steel spring. There is also a rubber spring bracket engaged to each frame rail. Each rubber spring bracket has a rubber spring that is aligned to make contact with the U-bolt seat upon a modest increase in chassis load beyond a very lightly loaded condition. Thereafter the rubber spring remains in contact with the widened rubber spring engagement face.

The symbiotic rubber spring device takes advantage of both of the previous prior art methods integrated into a single package. On a very lightly loaded chassis only the steel spring is functioning (See attached FIG. 5). After a very modest load increase, the rubber spring becomes an integral part of the suspension. When this occurs you immediately get a stepped increase in spring rate (See attached FIG. 4). After the initial step up, there is a linear increase in rate for a short distance and then the rate starts to go very non-linear. This gives the suspension a spring rate tailored to be optimal during all driving conditions. (See attached FIG. 4) There is a very low rate in lightly loaded situations where the center of gravity (CG) is lower. This gives good handling characteristics in lightly loaded conditions as well as good ride. In moderately loaded conditions there is a higher rate that matches the increased CG height. When a handling event occurs with these conditions you get a significantly higher rate on the side of the suspension that is getting load transferred to it from lateral acceleration. The final and most critical situation is when the chassis is loaded fully. This is the maximum CG height that causes the maximum load transfer during handling events. At this point the rate is starting to go very non-linear. When a handling event occurs during the maximum loaded condition the rubber spring rate goes asymptotic. (See attached FIG. 4) This means that the spring rate starts to approach infinity. This gives the most response when it is needed without sacrificing ride in other more lightly loaded situations. Another benefit of the design that we are presenting here is that the upper u-bolt seat has a wider pad than the spring which allows the u-bolts to fit the spring properly while still providing the necessary contact pad for the rubber spring to be fully supported during all loading conditions. (See attached FIG. 7) The step is made on both sides of the u-bolt seat even though it is only needed on the chassis side. The benefits of doing this are twofold. The first is that the rubber spring can sit back away from the tire more allowing for tire chain clearance. The second is that this allows the part to be installed in the plant without regard for its orientation. Another claim with this system is the size and shape of the rubber spring bracket to the frame. This bracket spreads out the very high loads into the frame rail without the use of a frame tie (cross-member) at this location (See attached FIG. 8). Since the loads into the frame are almost continuous it was critical that the bracket spread the loads out and do so with a minimum of material. This bracket was optimized for weight/cost/size.

The rubber spring is a primary functioning part of the suspension. It is not simply a cushioned axle travel limiter. This spring engages and stays engaged over almost the entire suspension travel. The only time it is not engaged is at extremely low loading, where it isn't needed. The second main difference is the use of the flared out u-bolt seat. This provides adequate support for the rubber spring while also allowing the rubber spring to be set far enough from the tire for use of tire chains.

The rubber spring has an engagement height and spring rate curve that enables it to function during all but the most lightly loaded conditions. The spring function has been tailored to optimize ride and handling characteristics. This has been done through the careful placement of the spring for initial engagement as well as the tailoring of the spring rate curve shape for optimal rate at each condition. The bracket that mounts it to the frame demonstrates the novel use of this spring. Since the spring is engaged almost all the time and because it is subjected to very high loading, the frame-mounting bracket is very large to spread loads out to prevent frame cracking and deformation. Also, the upper u-bolt seat allows for the rubber spring to be fully supported while far enough from the tire to meet the SAE J 683 tire chain clearance guidelines.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a prior art suspension system;

FIG. 2 is another prior art suspension system;

FIG. 3 is a graph of the response of the prior art suspension system of FIG. 2;

FIG. 4 is a graph of the response of a suspension system of the present invention;

FIG. 5 is suspension system made in accordance with this invention, shown in a very lightly loaded condition and installed on a chassis frame;

FIG. 6 is a partial view of a mobile vehicle suspension with the suspension of FIG. 5 shown installed;

FIG. 7A is a perspective of a U-bolt seat of the suspension system shown in FIG. 5;

FIG. 7B is a top down view of the seat of FIG. 7A;

FIG. 8A is a perspective of a rubber spring bracket of the suspension system shown in FIG. 5;

FIG. 8B is a side view of the rubber spring bracket of the suspension system shown in FIG. 8A;

FIG. 9 is the suspension system of FIG. 5, in a loaded condition; and

FIG. 10A is a perspective of the rubber spring bracket of FIG. 8 with a rubber spring installed;

FIG. 10B is a side view of the rubber spring bracket shown in FIG. 10A.

FIG. 10C is a front view of the rubber spring bracket shown in FIG. 10B.

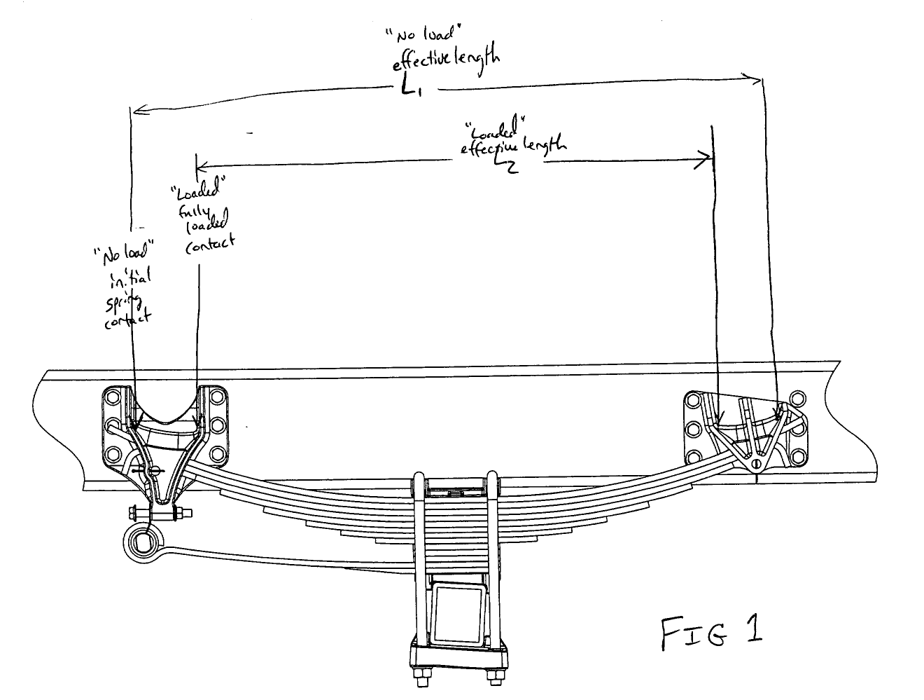

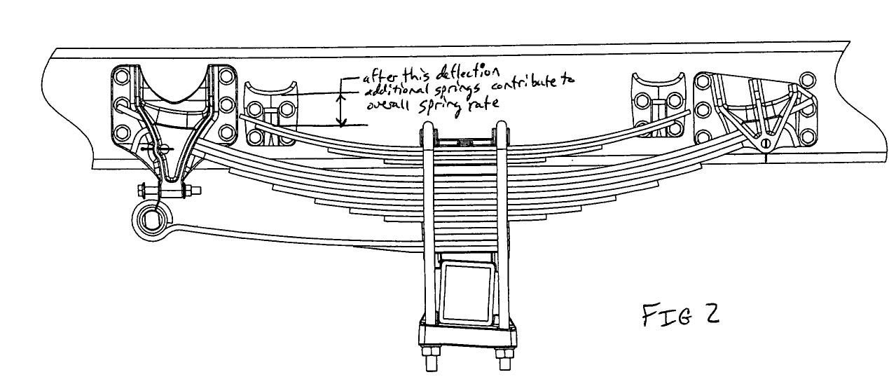

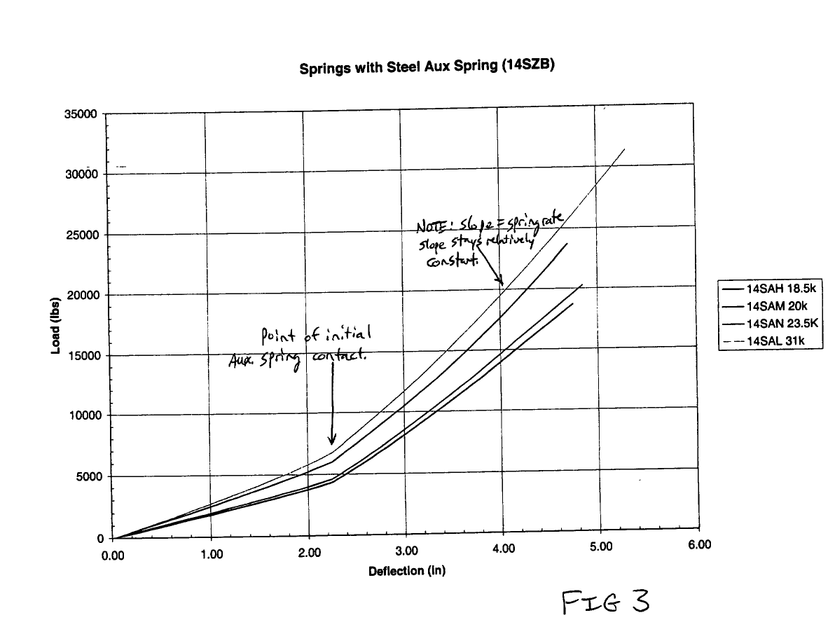

### DETAILED DESCRIPTION OF THE INVENTION

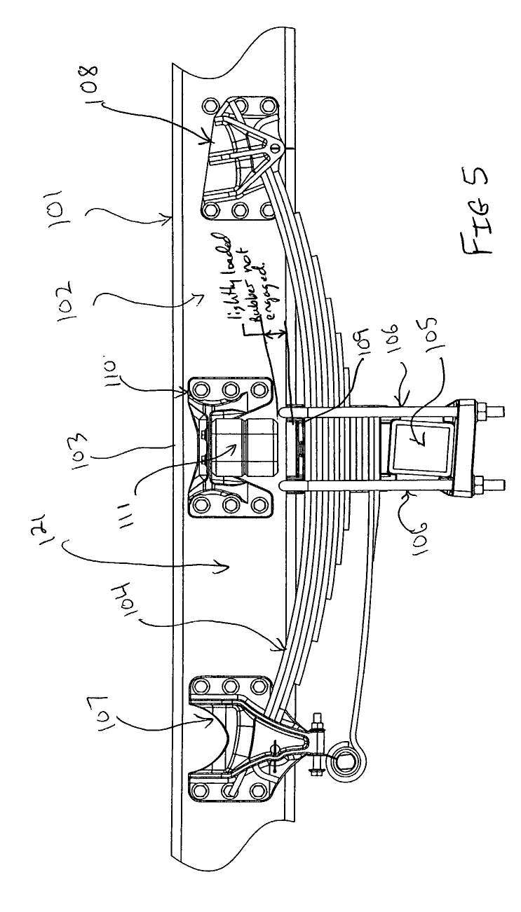

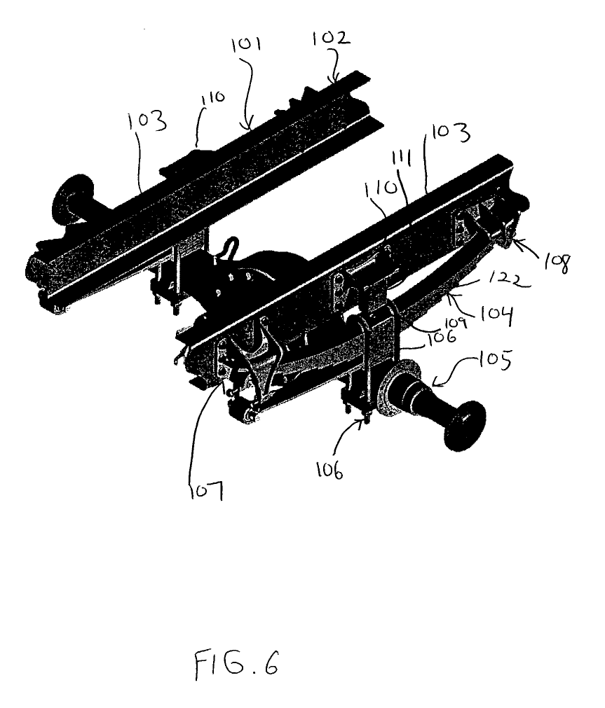

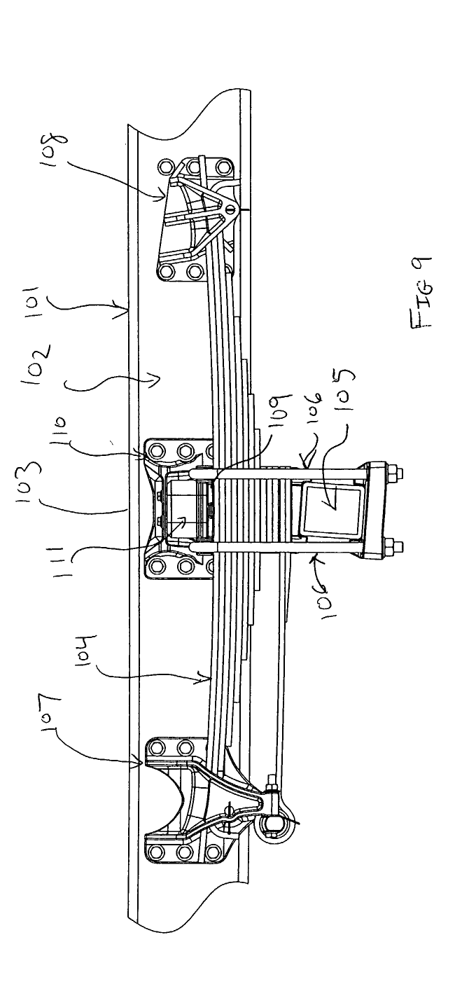

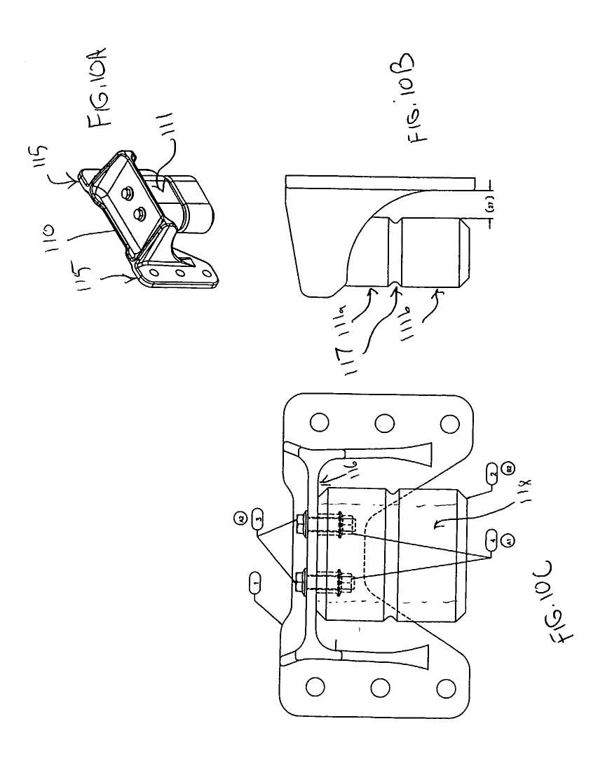

The vehicle 101 for which a suspension 119 is designed contains a chassis 102 with two parallel frame rails 103. See FIGS. 5 and 6. The suspension 119 contains a leaf spring 104 or set of leaf springs 104 engaged between a forward frame bracket or mounting device 107 and a rear frame bracket or mounting component 108; the frame mounting components 107 and 108 being engaged to a face 121 of each frame rail 103. The leaf spring 104 is engaged to a vehicle axle 105 through a pair of U-bolts 106. The leaf spring 104 may be steel or other strong yet flexible metals as these become available. There is a U-bolt seat 109 with a widened rubber spring engagement face 112. The widened portion is labeled 114. The U-bolt seat 109 is sandwiched between the curved portion 122 of the U-bolts 106 and the leaf spring 104 or set of springs 104. There is also a rubber spring bracket 110 engaged to each frame rail 103. Each rubber spring bracket 110 has a symbiotic elastomeric non-linear spring device or flexible spring 111 that is aligned to make contact with the U-bolt seat 109 upon a modest increase in chassis load beyond a very lightly loaded condition. Thereafter the flexible spring 111 remains in contact with the widened rubber spring engagement face. This is shown in FIG. 9.

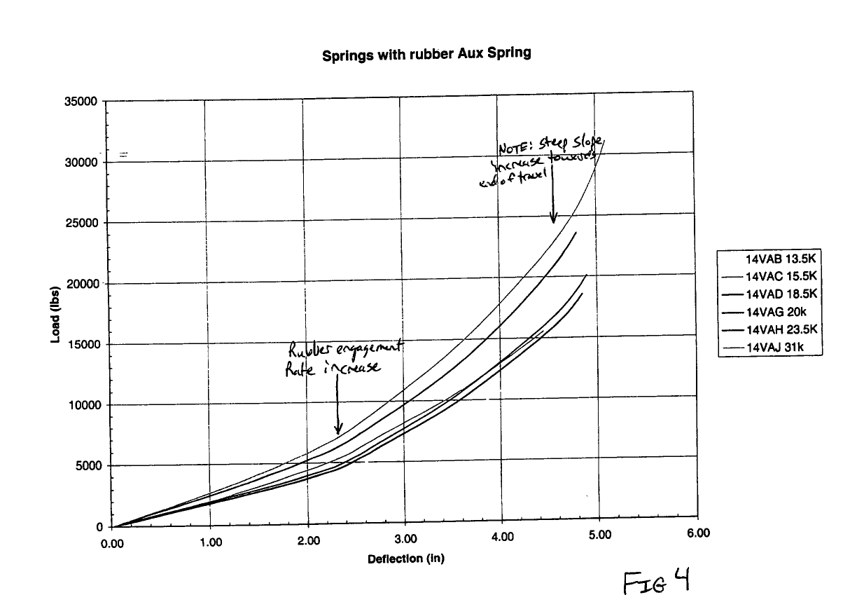

The symbiotic rubber spring device and suspension 119 takes advantage of both of the previous prior art methods integrated into a single package. On a very lightly loaded chassis only the steel spring 104 is functioning as weight bearing element in the suspension 119. (See attached FIG. 5) After a very modest load increase the flexible or rubber spring 111 becomes an integral part of the suspension 119 by becoming in contact with the metal spring 104. When this occurs the suspension 119 immediately gets a stepped increase in spring rate. See attached FIG. 4. After that there is a linear increase in rate for a short distance and then the rate starts to go very nonlinear. This gives the suspension 119 a spring rate tailored to be optimal during all driving conditions. See attached FIG. 4. An important aspect of the invention, is that the relative position of the elastomeric spring 111 to the metal spring 104 makes the suspension 119 respond in a non-linear fashion over some portion of its range of operation. The range of operation of the suspension 119 is defined by its weight or load carrying ability.

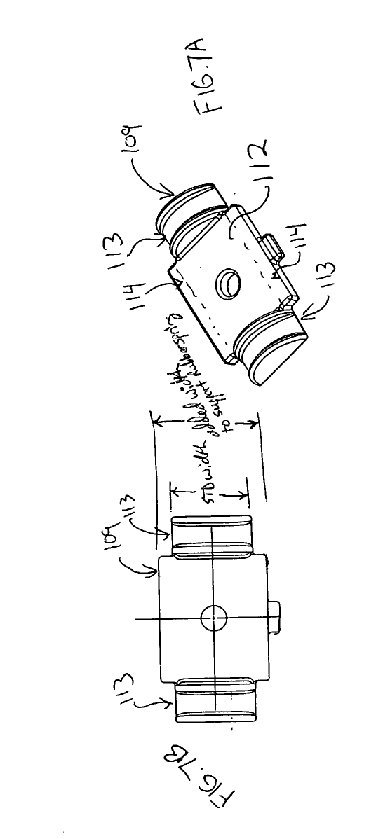

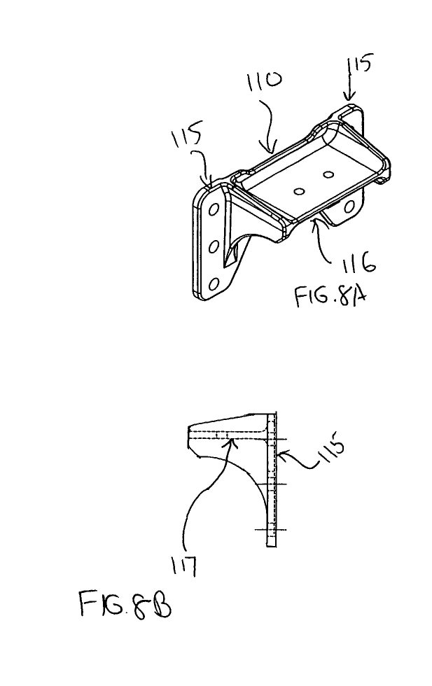

There is a very low rate in lightly loaded situations where the center of gravity (CG) is lower. This gives good handling characteristics in lightly loaded conditions as well as good ride. In moderately loaded conditions there is a higher rate that matches the increased CG height. When a handling event occurs with these conditions you get a significantly higher rate on the side of the suspension that is getting load transferred to it from lateral acceleration. The final and most critical situation is when the chassis is loaded fully. This is the maximum CG height that causes the maximum load transfer during handling events. At this point the rate is starting to go very nonlinear. When a handling event occurs during the maximum loaded condition the rubber spring rate goes asymptotic. See attached FIG. 4. This means that the spring rate starts to approach infinity. This gives the most response when it is needed without sacrificing ride in other more lightly loaded situations. Another benefit of the design that we are presenting here is that the upper u-bolt seat 109 has a wider pad or engagement face 112 than the spring 111 which allows the u-bolts 106 to fit the spring 111 properly while still providing the necessary contact pad for the rubber spring 111 to be fully supported during all loading conditions. See attached FIG. 7. The step or widened portion 114 is made on both sides of the u-bolt seat 109 even though it is only needed on the chassis side. Analysis has shown that in working models of the suspension 119, the rubber or flexible spring 111 comes in contact with the metal spring at least fifty percent 50% of the time over a range of load conditions. Also, it is important to note that the rubber or flexible spring 111 comes into contact with the metal spring before the suspension is loaded to capacity. In some embodiments this engagement range of the flexible spring 111 to the leaf spring 104 is accomplished by the flexibility of the leaf spring 104 in combination with the height of the flexible spring 111 relative to the leaf spring 104 in unloaded conditions. The object is to have the above-described response over a range of vehicle loading. The benefits of doing this are twofold. The first is that the rubber spring 111 can sit back away or inboard of more inboard from a tire engaged to a wheel of the axle 105 more allowing for tire chain clearance. The second is that this allows the part to be installed in the plant without regard for its orientation. Another claim with this system is the size and shape of the rubber spring bracket 110 to the frame 102. This bracket 110 spreads out the very high loads into the frame rail 103 without the use of a frame tie (cross-member) at this location. See attached FIG. 8. Since the loads into the frame 102 are almost continuous it was critical that the bracket 110 spread the loads out and do so with a minimum of material. This bracket was optimized for weight/cost/size.

The rubber or elastomeric spring 111 is a primary functioning part of the suspension 119. It is not simply a cushioned axle travel limiter. This spring 111 engages and stays engaged over almost all the significant portion of the movement of suspension 119. The only time it is not engaged is at extremely low loading, where it isn't needed. The second main difference is the use of the flared out u-bolt seat 109. This provides adequate support for the rubber spring 111 while also allowing the rubber spring to be set far enough from the tire for use of tire chains. The height of the flexible or rubber spring 111 away from the leaf spring 104 in the unloaded condition is such that the two move into contact as load is increased so as to change overall response of the suspension 119. This non-linear response results from the symbiotic elastomeric device.

The rubber spring 111 has an engagement height and spring rate curve that enables it to function (i.e. come in contact with the leaf spring) during all but the most lightly loaded conditions. The spring function has been tailored to optimize ride and handling characteristics. This has been done through the careful placement of the spring for initial engagement as well as the tailoring of the spring rate curve shape for optimal rate at each condition. The bracket 110 that mounts it to the frame 102 demonstrates the novel use of this spring 111. Since the spring 111 is engaged almost all the time and because it is subjected to very high loading, the frame-mounting bracket 110 is very large to spread loads out to prevent frame cracking and deformation. Also, the upper u-bolt seat 109 allows for the rubber spring 111 to be fully supported while far enough from the tire to meet the Society of Automotive Engineers (SAE) J 683 tire chain clearance guidelines.

The elastomeric spring 111 may be of various sizes and shapes, the common element being that the spring 111 is positioned above an engagement area of the leaf spring 104 at such a height that it comes in contact with the leaf spring 104 during a significant portion of the load range of the suspension and that this engagement of the elastomeric spring 111 with the leaf spring makes the overall suspension response non-linear over at least a portion of the range of operation of the suspension 119.

In one embodiment, the spring 111 is made up of two pez or oblong cylindrically shaped pads, an upper pad 111a and a lower pad 111b. The pads are in this embodiment integral to the same piece of rubber. There may be a narrow gap portion 117 to aid in achieving the proper spring rate. The interior 118 may be hollow to allow for varying response of the flexible spring. The flexible spring is described as rubber however other elastomeric materials may be appropriate.

As described above, suspension 119 and vehicle 101 with the suspension 119 installed provide a number of advantages, some of which have been described above and others of which are inherent in the invention. Also modifications may be proposed to the suspension 119 and vehicle 101 with the suspension 119 installed without departing from the teachings herein.

We claim:

1. A suspension for a mobile vehicle, the vehicle having a chassis with two parallel frame rails, the suspension comprising:
a leaf spring engaged between a forward mounting component and a rear mounting component to each frame rail, said front and rear mounting components each being engageable to a face of each frame rail;
each said leaf spring being engageable to a vehicle axle through a pair of U-bolts;
a flexible spring bracket engageable to each frame rail above an engagement area of said leaf springs between said front and rear mounting components; and
each said spring bracket having an elastomeric spring aligned and spaced from said leaf spring to make contact with said engagement area of said leaf spring upon increases in chassis load beyond a lightly loaded chassis condition, said elastomeric spring causing said suspension response to be non-linear over a portion of operation.

2. The suspension of claim 1, wherein:
said elastomeric spring is in contact with said engagement area of said leaf springs over a significant amount of the range of non-transient suspension operation.

3. The suspension of claim 2, wherein:
said elastomeric spring is in contact with said engagement area for at least fifty percent of said suspension operation.

4. The suspension of claim 3, wherein:
a U-bolt seat is sandwiched between said U-bolts and said leaf spring; and
said U-bolt seat has a widened elastomeric engagement face and said widened elastomeric engagement face acts as said engagement area of said leaf springs.

5. The suspension of claim 4, wherein:
said elastomeric spring is made up of two pez shaped pads, an upper pad and a lower pad; and
said pads being integral.

6. The suspension of claim 5, wherein:
said elastomeric spring pads having a narrow gap portion at an engagement zone between said pads; and
said elastomeric pads having a partially hollow interior.

7. A suspension for a mobile vehicle, the vehicle having a chassis with two parallel frame rails, comprising:
a leaf spring engaged between a forward frame bracket and a rear frame bracket;
said frame brackets being engageable to a face of each frame rail;
each said leaf spring being engageable to a vehicle axle through a pair of U-bolts;
a U-bolt seat with a widened spring engagement face;
said U-bolt seat being sandwiched between a curved portion of said U-bolts and said leaf spring;
a bracket engageable to each frame rail; and
each said spring bracket having a symbiotic elastomeric spring device aligned to make contact with said U-bolt seat upon a modest increase in chassis load beyond a light load condition, and thereafter said elastomeric spring device in contact with said widened spring engagement face.

8. A mobile vehicle, comprising:
a chassis with two parallel frame rails;
a leaf spring engaged between a forward mounting component and a rear mounting component to each frame rail, said front and rear mounting components each being engaged to a face of each frame rail;
each said leaf spring being engaged to a vehicle axle through fasteners;
a flexible spring bracket engaged to each frame rail above an engagement area of said leaf springs between said front and rear mounting components; and
each said spring bracket having an elastomeric spring aligned and spaced from said leaf spring to make contact with said engagement area of said leaf spring upon increases in chassis load beyond a lightly loaded chassis condition, said elastomeric spring causing said suspension response to be non-linear over a portion of operation.

9. The vehicle of claim 8, wherein:
said elastomeric spring is in contact with said engagement area of said leaf springs over a significant amount of the range of non-transient suspension operation.

10. The vehicle of claim 9, wherein:
said elastomeric spring is in contact with said engagement area for at least fifty percent of said suspension operation.

11. The vehicle of claim 10, wherein:
a U-bolt seat is sandwiched between said U-bolts and said leaf spring; and
said U-bolt seat has a widened elastomeric engagement face and said widened elastomeric engagement face acts as said engagement area of said leaf springs.

12. The vehicle of claim 11, wherein:
said elastomeric spring is made up of two pez shaped pads, an upper pad and a lower pad; and
said pads being integral.

13. The vehicle of claim 12, wherein:
said elastomeric spring pads having a narrow gap portion at an engagement zone between said pads; and
said elastomeric pads having a partially hollow interior.

14. A mobile vehicle, comprising:
a chassis with two parallel frame rails;
a leaf spring engaged between a forward frame bracket and a rear frame bracket;
said frame brackets being engageable to a face of each frame rail;
each said leaf spring being engageable to a vehicle axle through a pair of U-bolts;
a U-bolt seat with a widened spring engagement face;
said U-bolt seat being sandwiched between a curved portion of said U-bolts and said leaf spring;
a bracket engageable to each frame rail; and
each said spring bracket having a symbiotic elastomeric spring device aligned to make contact with said U-bolt seat upon a modest increase in chassis load beyond a light load condition, and thereafter said elastomeric spring device in contact with said widened spring engagement face.

15. The vehicle of claim 14, wherein:
said elastomeric spring is made up of two pez shaped pads, an upper pad and a lower pad; and
said pads being integral.

16. The vehicle of claim 15, wherein:
said elastomeric spring pads having a narrow gap portion at an engagement zone between said pads; and
said elastomeric pads having a partially hollow interior.
